(19) United States
(12) Patent Application Publication
(10) Pub. No.: US 2009/0154635 A1
(43) Pub. Date: Jun. 18, 2009

(54) DRAINAGE APPARATUS AND DRAINAGE METHOD FOR REACTOR COOLANT SYSTEM

(75) Inventors: Jun-Hyung KIM, Yeonggwang-gun (KR); Won-Jeong BAEK, Jeongeup-si (KR)

Correspondence Address: HOLME ROBERTS & OWEN LLP, 1700 LINCOLN STREET, SUITE 4100, DENVER, CO, 80203, US

(73) Assignee: KOREA PLANT SERVICE & ENGINEERING CO., LTD., Seongnam (KR)

(21) Appl. No.: 12/190,016

(22) Filed: Aug. 12, 2008

(30) Foreign Application Priority Data
Dec. 18, 2007 (KR) 10-2007-0133451

(51) Int. Cl. G21D 1/04

(52) U.S. Cl. 376/352

(57) ABSTRACT

A drainage apparatus and a drainage method for a reactor coolant system are disclosed. According to the drainage apparatus and the drainage method, the gravity drainage procedure for performing the decomposition maintenance of a main valve forming the pressure boundary part between the RCS and the safety injection system is improved by a forced drainage procedure using a drainage pump, and there are the effects that working period for a planned preventive maintenance is shortened, liquid waste of a coolant of the reactor is not generated, reprocessing costs are decreased, and the economical efficiency and the safety of the nuclear power plant are improved.

### BACKGROUND OF THE INVENTION

1. Field of the Invention

The present invention relates to drainage of a coolant of a reactor, and more particularly, to an apparatus and method for draining the coolant used in a reactor coolant system to repair various types of valves installed to pressure boundary parts of the reactor coolant system when nuclear fuel is replaced in a nuclear power plant.

2. Description of the Related Art

Generally, the nuclear power plant includes a system having more than one hundred individual functions. With respect to the reactor, the system includes a device that provides steam, a steam turbine for operating a generator, a generator system, and other accompanied equipment. The reactor produces nuclear energy that is changed to other energies, such as electricity, so that it can be practically applied in real life. A reactor is an apparatus, used for a variety of purposes, where heat is generated by artificially controlling a chain fission reaction of a fissionability material, a radio isotope and Plutonium are formed, and a radiation field is formed.

Generally, a safety injection system is installed to the nuclear power plant to ensure the safety of the reactor by injecting Boric acid water into a reactor core in order to control the degree of the reaction in the reactor core. The Boric acid water also acts to cool the reactor core in an emergency and to cool the coolant of the reactor when the reactor stops its operation. The system has various valves that prevent backward flow of the coolant at a high temperature, high pressure and high radioactivity, generated in the Reactor Coolant System (RCS), into the safety injection system. These valves also prevent internal and external leakages.

The reactor described above is a pressurized light water reactor having two coolant circuits, where the RCS circulates the cooling water in a closed circuit, and where a performance test of a safety valve used in a pressurizer system is practiced to uniformly maintain the pressure of the RCS. The conventional draining method of the RCS for decomposition inspection of a pressure boundary part of the RCS will be described in detail with reference to the following annexed drawings.

FIGS. 1 and 2 are schematic views illustrating a drainage apparatus and a drainage method for a conventional reactor coolant system.

Referring to FIGS. 1 and 2, in the drainage apparatus and the drainage method for the conventional reactor coolant system, first an isolating valve 10 of the RCS hot leg is opened, and then the coolant is directly drained into a recharging water tank 30 by a low pressure safety injection pump 20.

Afterwards, according to the opening of a manual valve 40 of the RCS cold leg, gravity drainage into the reactor drainage tank 60 through a drain header 50 of the reactor drainage tank occurs, which lasts approximately 7 to 9 hours.

Here, a drainage procedure of the RCS is comprised of the following method: the low pressure safety injection pump 20 installed to a safety injection system drains the RCS to a predetermined water level; the pump is stopped in below the predetermined water level taking account of the safety of the system; and then the remaining water is transferred into the drainage procedure by the gravity drainage.

Taking account of economical efficiency and safety of the system property and an operation of the reactor power plant, a decomposition inspection of the valve, such as the maintenance being practiced by drainage of circuit water of the RCS in a withdrawal state of nuclear fuel, has the following problems.

First, drainage is practiced by the low pressure safety injection pump 20 so that the water level of the RCS is approximately 31 m (approximately 101.7 feet) to 32 m (105 feet). However, the pump is often damaged by an air pocket in the intake part of the low pressure safety injection pump 20 that prevents drainage of the RCS water level to less than 31 m (101.7 feet)-32 m (105 feet), and thus generates a serious system safety problem.

Second, the delay of an operation setting frequently occurs during a main process because the gravity drainage time of the above drainage procedures is planned into the main process as a planned preventive maintenance procedure, the drainage time required being about eight hours, and with the passage of time, the drainage of the RCS water is not completely accomplished in the decomposition procedure of the valve.

Third, there are various other problems, as working is stopped, removing the reminding fluid requires time, and exposure dose of a radiation is increased. Also, securing perfect maintenance quality is difficult, because the reminding fluid of the RCS continually flows out as a step of precision processing work through precision inspection of a sealing part and damaged part on the main valves, which prevents a water leakage through the rear end of the RCS valves, when the power plant is normally operated.

Fourth, the drainage of the RCS water is necessary to maintain the various valves installed to the pressure boundary part of the RCS and maintain the system during a replacement period of nuclear fuel, however due to the drainage method using the fluid level, considerable time is required for drainage and liquid waste is generated.

As a result, the area surrounding a nuclear power plant widely polluted by forced drainage through a valve body that is practiced to prevent a delay in construction workers can needlessly exposed to radiation during a change of personnel for processing a recontamination, and the disposal costs of the liquid waste of the RCS are increased. Therefore, the economical efficiency of the nuclear power plant is lowered.

### SUMMARY OF THE INVENTION

Therefore, the present invention has been made in view of the above problems, and provides a drainage apparatus and a drainage method of a coolant of the RCS which the gravity drainage procedure for performing a decomposition maintenance of a main valve forming the pressure boundary part between the RCS and the safety injection system can be improved by a forced drainage procedure using a drainage pump.

In accordance with an exemplary embodiment of the present invention, the present invention provides a drainage apparatus for a reactor coolant system including: a forced drainage pump installed in a drainage line of a hot leg of a reactor in order to forcibly drain a system water of a coolant injected into the reactor coolant system into a drainage tank of the reactor; a valve installed in the drainage line and a circulation line of the hot leg of the reactor in order to intercept the system water being forcibly drained into the drainage tank of the reactor; a drainage pump for discharging in order to collect all system water of the coolant being forcibly drained into the drainage tank of the reactor; a water level gauge installed in one side of the drainage tank of the reactor in order to prevent an overflow state of the system water of the coolant being drained into the drainage tank of the reactor and to measure a water level of the drainage tank of the reactor; a flow meter installed in an injection pipe of the drainage tank of the reactor and for confirming the time required for drainage and the flow rate of the drainage hereafter by measure the flow rate of the system water of the coolant being drained through a hot leg of the reactor; a pressure gauge of the drainage pump installed in one side of the forced drainage pump and for measuring a pressure of the system water of the coolant being drained; and a site glass for confirming the flow rate of the system water of the coolant being drained.

### BRIEF DESCRIPTION OF THE DRAWINGS

The features and advantages of the present invention will be more apparent from the following detailed description in conjunction with the accompanying drawings, in which:

FIGS. 1 and 2 are schematic views illustrating a drainage apparatus and a drainage method for a conventional reactor coolant system;

FIGS. 3 and 4 are schematic views illustrating a drainage apparatus and a drainage method for the reactor coolant system according to the present invention; and

FIG. 5 is a flow chart illustrating the drainage method for the reactor coolant system according to the present invention.

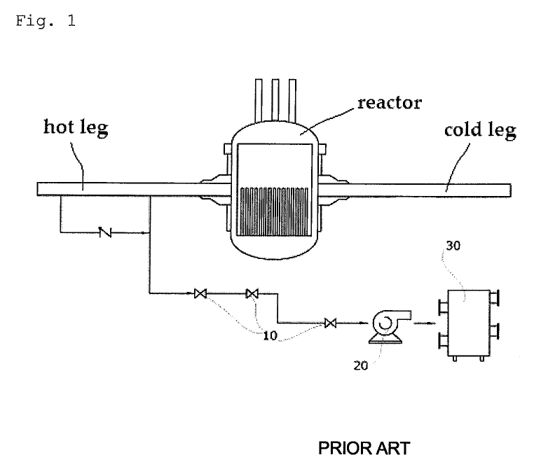

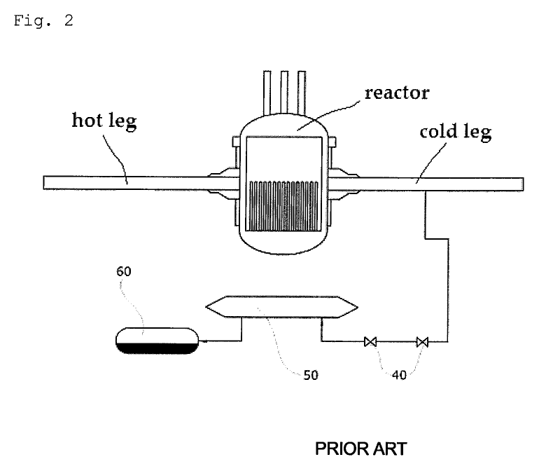

### BRIEF DESCRIPTION OF SYMBOLS IN THE DRAWINGS

100: hot leg division valve

200: drainage valve

300: forced drainage pump

400: drainage tank

500: test valve

600: drainage pump

700: leakage division valve

800: exhaust valve

900: nitrogen supply valve

1000: water recharging tank

1100: coolant pump

### DETAILED DESCRIPTION OF THE PREFERRED EMBODIMENTS

Preferred embodiments of the present invention are described in detail with reference to the annexed drawings.

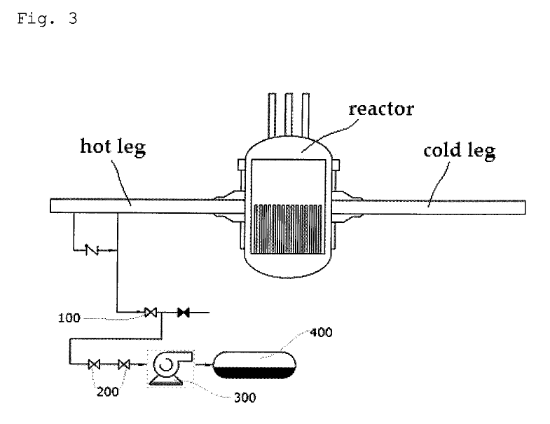

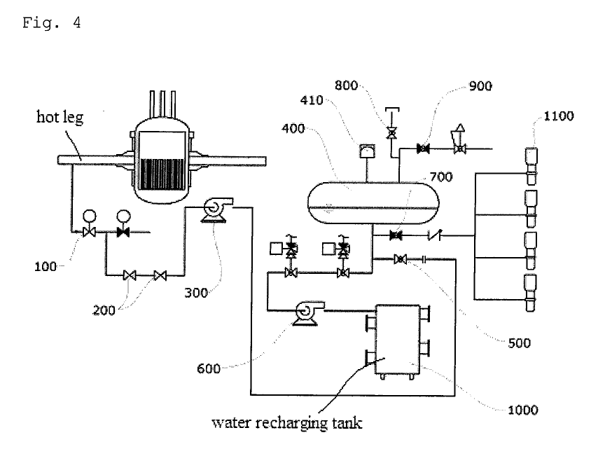

FIGS. 3 and 4 are schematic views illustrating a drainage apparatus and a drainage method for the reactor coolant system according to the present invention.

Referring to FIGS. 3 and 4, a drainage apparatus for the reactor coolant system comprises a forced drainage pump 300, a valve, a drainage pump, a water level gauge, a flow meter and a pressure gauge of the drainage pump and a site glass. The water level gauge, the flow meter, the pressure gauge and a site glass are not shown in the drawings.

The forced drainage pump 300 is installed in a drainage line of a hot leg of the reactor to forcibly drain a coolant system water injected into the RCS into a drainage tank 400 of the reactor.

The valve is installed in the drainage line and a circuit line of the hot leg of the reactor and it serves to interrupt and supply the system water being forcibly drained into the drainage tank 400 of the reactor. The valve comprises a hot leg division valve 100, a drainage valve 200, a testing valve 500, a nitrogen supply valve 900 and a leakage division valve 700.

The hot leg division valve 100 is installed in the circuit line to circulate a coolant system water of the hot leg of the reactor into the cold leg.

The drainage valve 200 is installed in the drainage line connected to the circuit line.

The testing valve 500 is installed between the forced drainage pump 300 and the drainage tank 400, and it is possible to two-way flow the coolant system water into the drainage pump 600 and the drainage tank 400 of the reactor.

The nitrogen supply valve 900 interrupts an inflowing pressure of the coolant system water that flows into the drainage tank 400 by removing nitrogen pressure in the drainage tank 400 of the reactor.

The leakage division valve 700 interrupts the coolant system water that flows into the coolant pump 1100 when the coolant system water is forcibly drained.

The drainage pump 600 of the reactor discharges the coolant system water being forcibly drained into the drainage tank 400 of the reactor into a water recharging tank 1000 so that all the coolant system water is collected when the apparatus is automatically moved and stopped by increasing the water level of the drainage tank 400 of the reactor.

The water level gauge is installed in one side of the drainage tank 400 of the reactor in order to prevent an overflow state of the coolant system water of the reactor being drained into the drainage tank 400 of the reactor and to measure a water level of the drainage tank 400 of the reactor.

The flow meter is installed in an injection pipe of the drainage tank 400 of the reactor, and it confirms the time required for drainage and the flow rate of the drainage hereafter by measuring the flow rate of the coolant system water being drained through a hot leg.

The pressure gauge of the drainage pump is installed in one side of a forced drainage pump 300, and it measures the pressure of the coolant system water being drained.

The site glass confirms the flow rate of the coolant system water being drained.

Here, a forced drainage method of the RCS using the drainage pump performs a role to circuit the coolant obtained from the hot leg of the reactor into the cold leg, so that decay heat is continually removed (cooling) in order to be consistently maintain a temperature of the coolant system and a peripheral area for an inspection and examination of the reactor power plant and a recharge of the nuclear fuel, to prevent much heat from being generated by the decay heat that is generated by nuclear fission when the operation of the reactor is stopped; and a constant heating rate is maintained when the power plant is operated.

Also, the RCS hot leg division valve 100 of the safety injection system has a temperature of less than 177° C. on the RCS hot leg, the division valve 100 is opened when a pressure of a pressurizer is approximately less than 410 psi, and the coolant system water is directly and forcibly drained into the drainage tank 400 of the reactor by the drainage pump 300 in the drainage line of the safety injection system of the hot leg injection, after completely opening the RCS hot leg division valve 100.

First, the hot leg division valve 100 of the RCS and the drainage valve 200 of the hot leg safety injection system are opened, and the coolant system water is forcibly drained by the drainage pump 300 of the RCS in the latter end of the drainage valve 200 of the hot leg safety injection system.

The coolant system water, forcibly drained through a flow channel of the RCS, two-way flows inside the drainage pump 600 and the drainage tank 400 of the reactor by the test valve 500 of an outlet side the drainage tank 400 of the reactor being opened. The drainage pump 600 of the reactor is automatically operated so that all system water of the RCS is collected into the water recharging tank 1000 according to the increase of the water level in the drainage tank 400 of the reactor.

Next, the nitrogen supply valve 900 of the drainage tank 400 of the reactor is closed, and thus an inflow resistance is prevented by removing the nitrogen of about 3 psi pressure in the drainage tank 400 of the reactor.

After that, an exhaust valve 800 of the drainage tank 400 of the reactor is opened to prevent damage of a rupture disc 410 of the drainage tank 400 of the reactor.

Lastly, the coolant system water of the RCS does not flow into the drainage tank 400 of the reactor by being interrupted by a leakage of the drainage pump 600 of the reactor or by a leakage line according to closing of the leakage division valve 700 when the coolant system water is forcibly drained.

On the other hand, the water level gauge (not shown) is installed for checking the water level of the drainage tank 400 of the reactor in order to prevent an over-flow of the coolant system water through the drainage tank 400 of the reactor, for checking the water level of the drainage tank 400 of the reactor by the water level gauge of a control board, and for stopping the operation of the forced drainage pump 300 of the RCS when the system of the drainage tank 400 is not operated.

Also, the drainage pump using the drainage line of the hot leg of the RCS and the parts thereof are installed, and thus a soft hose is installed in a front end of the drainage pump to minimize the length of an inlet part side. And, a pressure gauge and a site glass (not shown) are installed to minimize loss of the flow rate and to prevent excessive drainage when the system water of the RCS is forcibly drained. Also, the pressure gauge is installed in the front end of the drainage pipe to display states of the excessive drainage and an actual drainage when the drainage pump is operated, and the site glass is installed in the backward end of the drainage pipe to expose a flow rate to the naked eye.

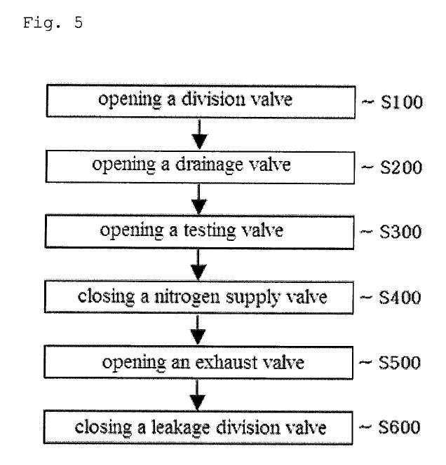

FIG. 5 is a flow chart illustrating a drainage method for a reactor coolant system according to the embodiment of the present invention.

Referring to FIG. 5, a division valve 100 installed in a circuit line of a hot leg is opened in order to circulate a system water of the hot leg into a cold leg (S100). A pair of a drainage valve 200, installed in a drainage line of a safety injection system of the hot leg connected to the circuit line, is opened, so that coolant system water flows into a forced drainage pump 300 (S200). A testing valve installed between the forced drainage pump 300 and the drainage tank 400 is opened, so that the coolant system water, forcibly drained, can flow into two-way of the drainage pump 600 and the drainage tank 400 and the whole quantity can be collected (S300).

After that, a nitrogen supply valve 900 is closed to interrupt a inflowing pressure of the coolant system water that flows into the drainage tank 400 by remove a nitrogen pressure in the drainage tank 400 (S400). The exhaust valve 800 of the drainage tank 400 of a reactor is opened (S500). A leakage division valve 700 is closed (S600) to interrupt the coolant system water that flows into the coolant pump 1100 of the reactor when the coolant system water is forcibly drained.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A drainage apparatus for a reactor coolant system comprising:
a forced drainage pump installed in a drainage line of a hot leg of a reactor in order to forcibly drain a system water of a coolant injected into the reactor coolant system into a drainage tank of the reactor;
a valve installed in the drainage line and a circulation line of the hot leg of the reactor in order to intercept the system water being forcibly drained into the drainage tank of the reactor;
a drainage pump for discharging in order to collect all the system water of the coolant being forcibly drained into the drainage tank of the reactor;
a water level gauge installed in one side of the drainage tank of the reactor in order to prevent an overflow state of the system water of the coolant being drained into the drainage tank of the reactor and to measure a water level of the drainage tank of the reactor;
a flow meter installed in an injection pipe of the drainage tank of the reactor and for confirming a time required for drainage and a flow rate of the drainage hereafter by measure the flow rate of the system water of the coolant being drained through the hot leg of the reactor;
a pressure gauge of the drainage pump installed in one side of the forced drainage pump and for measuring a pressure of the system water of the coolant being drained; and
a site glass for confirming the flow rate of the system water of the coolant being drained.

2. The drainage apparatus according to claim 1, wherein the valve comprises:
a division valve of the hot leg installed in a circulation line so that the system water of the coolant flowing through the hot leg of the reactor is circulated through a cold leg;
a drainage valve installed in the drainage line connected with the circulating line;
a testing valve installed between the forced drainage pump and the drainage tank so that the system water of the coolant which is forcibly drained can be flowed into two-way of the drainage pump and the drainage tank and a whole quantity can be collected;
a nitrogen supply valve for interrupting an inflowing pressure of a coolant system water being flowed into the drainage tank by remove a nitrogen pressure in the drainage tank; and
a leakage division valve for interrupting the coolant system water being flowed into a coolant pump when the coolant system water is forcibly drained.

3. A drainage method for a reactor coolant system, comprising:
a) opening a division valve installed in a circulation line of a hot leg in order to circulate a system water of the hot leg into a cold leg;
b) opening a pair of a drainage valve which is installed in a drainage line of a safety injection system of the hot leg connected to the circuit line and leads an inflow of a coolant system water into a forced drainage pump;
c) opening a testing valve installed between the forced drainage pump and a drainage tank so that the coolant system water which is forcibly drained can be flowed into two-way of a drainage pump and the drainage tank and a whole quantity can be collected;
d) closing a nitrogen supply valve interrupting a inflowing pressure of the coolant system water being flowed into the drainage tank by remove a nitrogen pressure in the drainage tank and opening the drainage valve of the drainage tank of a reactor; and
e) closing a leakage division valve interrupting the coolant system water being flowed into a coolant pump when the coolant system water is forcibly drained.
